(19) United States
(12) Patent Application Publication
(10) Pub. No.: US 2007/0247586 A1
(43) Pub. Date: Oct. 25, 2007

(54) Optical actuation system with deformable polymer film

(75) Inventors: Nelson V. Tabirian, Winter Park, FL (US); Svetlana Serak, Winter Park, FL (US); Xiao-Man Dai, Export, PA (US); Timothy Bunning, Dayton, OH (US)

Correspondence Address: Nelson V. Tabirian;Suite i, 809 S. Orlando Ave., Winter Park, FL, 32789, US

(73) Assignee: BEAM Engineering for Advanced Measurements Co., Winter Park, FL (US)

(21) Appl. No.: 11/408,344

(22) Filed: Apr. 22, 2006

(51) Int. Cl. G02F 1/13

(52) U.S. Cl. 349/200

(57) ABSTRACT

The objective of the present invention is to provide means for reversibly controlling the shape of a polymer with a single light beam of low power density, inducing large range of polymer deformation angles, both positive and negative, at high speed, and at room temperature. The invention relates to variable optical components such as variable focus mirrors, lenses, light deflectors, shutters, attenuators, switches, and to remotely operated mechanical actuators.

### STATEMENT REGARDING FEDERALLY SPONSORED RESEARCH OR DEVELOPMENT

This invention was made with Government support under SBIR Contract No. Contract # F33615-03-C-5444.

Rights of the Government

The invention described herein may be manufactured and used by or for the Government of the United States for all governmental purposes without the payment of any royalty.

### CROSS-REFERENCES

[1] Y. Yu, M. Nakano, and T. Ikeda, “Directed bending of a polymeric film by light,” Nature, Vol. 425, 145 (2003).
[2] T. Ikeda, M. Nakano, Y. Yu, O. Tsutsumi, and A. Kanazawa, “Anisotropic bending and unbending behavior of azobenzene liquid-crystalline gels by light exposure,” Adv. Mater., Vol. 15, 201-205 (2003).
[3] Y. Yu, M. Nakano, A. Shishido, T. Shiono, and T. Ikeda, “Effect of cross-linking density on photoinduced bending behavior of oriented liquid-crystalline network films containing azobenzene,” Chem. Mater., Vol. 16, 1637-1643 (2004).
[4] M. Camacho-Lopez, H. Finkelmann, P. Palffy-Muhoray, and M. Shelley, “Fast liquid-crystal elastomer swims into the dark,” Nature, Vol. 3, 307-310 (2004).
[5] N. Tabiryan, S. Serak, and Xiao-Man Dai, T. Bunning, Polymer film with optically controlled form, and actuation, Vol. 13, 7442-7448 (2005).
[6] N. Tabiryan, “Room temperature azobenzene liquid crystals and their photonics applications”, Oral presentation at the 8^{th} International Conference on Frontiers of Polymers and advanced Materials (ICFPAM), Cancun, Mexico, Apr. 25, 2005.
[7] N. Tabiryan, “Room temperature azobenzene liquid crystals and their photonics applications”, Oral presentation at the conference on New Optical Materials and Applications, Cetraro, Italy, May 29-Jun. 4, 2005.
[8] A. Makushenko, O. Stolbova, and B. Neporent, “Reversible orientational photodichroism and photoisomerization of aromatic azo-compounds,” Opt. Spectr. 31, 295-302 (1971).
[9] M. Eich, J. Wendroff, B. Reck, H. Ringsdorf, and H. Schmidt, “Nonlinear optical self-diffraction in a mesogenic side chain polymer,” Macromol. Chem. Phys. 186, 2639-2647 (1985).
[10] U. Wiesner, N. Reynolds, C. Boeffel, and H. W. Spiess, “An infrared spectroscopic study of photo-induced reorientation in dye containing liquid-crystalline polymers,” Liquid Crystals 11, 251-267 (1992).
[11] N. Holme, L. Nikolova, T. Norris, S. Hvilsted, M. Pederson, R. Berg, P. Rasmussen, and P. Ramanujam, “Physical processes in azobenzene polymers on irradiation with polarized light,” Macromol. Symp. 137, 83-103 (1999)
[12] O. Yaroshchuk, Yu. Zakrevskyy, A. Kiselev, J. Stumpe, and J. Lindau, “Spatial reorientation of azobenzene side groups of a liquid crystalline polymer induced with linearly polarized light,” Eur. Phys. J. E6, 57-67 (2001).
[13] C. Kempe, M. Rutloh, and J. Stumpe, “Photo-orientation of azobenzene side chain polymers parallel or perpendicular to the polarization of red He—Ne light,” J. Phys.: Condens. Matter. 15, S813-S823 (2003).
[14] O. Tsutsumi, Y. Demachi, A. Kanazawa, T. Shiono, T. Ikeda, and Yu. Nagase, “Photochemical phase-transition behavior of polymer liquid crystals induced by photochemical reaction of azobenzenes with strong donor-acceptor pairs,” J. Phys. Chem. B 102, 2869-2874 (1998).
[15] H.-K. Lee, K. Doi, A. Kanazawa, T. Sciono, T. Ikeda, T. Fujisawa, M. Aizawa, and B. Lee, “Light-scattering-mode optical switching and image storage in polymer/liquid crystal composite films by means of photochemical phase transition,” Polymer 41, 1757-1763 (1999).
[16] N. Tabiryan, S. Serak, and V. Grozhik, “Photoinduced critical opalescence and reversible all-optical switching in photosensitive liquid crystals,” J. Opt. Soc. Am. B 20, 538-544 (2003).
[17] N. Tabiryan, U. Hrozhyk, and S. Serak, “Nonlinear refraction in photoinduced isotropic state of liquid crystalline azobenzenes,” Phys. Rev. Lett. 93, 113901-1-4 (2004).

### U.S. PATENT DOCUMENTS

| | | |
|---|---|---|
| 6,513,939 | February 2003 | Fettig |
| 3,886,310 | May 1975 | Guldberg, et al. |
| 4,013,345 | May 1977 | Roach |
| 4,822,155 | April 1989 | Waddell |
| 4,059,346 | November 1977 | Levine, et al. |
| 4,466,706 | August 1984 | Lamothe, II |
| 6,907,153 | June 2005 | Bozler, et al. |

### BACKGROUND OF THE INVENTION

In the field of optics, deformable shape materials, particularly, polymer films and membranes, are used for producing variable focus lenses, variable deflection mirrors, switches, shutters, light valves, and other optical components for controlling with propagation of radiation in a variable and adjustable manner. In the prior art, such a control was obtained using mechanical forces, hydrodynamic pressure, electric fields, and optical radiation. For example, the variable focus mirror presented in the U.S. Pat. No. 4,059,346 comprises an elastic disk having a mirror finish on one face. A plurality of mechanical connections attached to the disk cause the disk to flex by application of a force distributed along the edges of the disk, which is mounted in a special mechanical holder. A flexible mirror comprising reflectively coated elastomer overlaying a circular chamber and having its tension controlled around the periphery is described in the U.S. Pat. No. 4,822,155.

An example of a variable focus lens controlled by hydrodynamic pressure is presented in the U.S. Pat. No. 4,466,706 which describes an adjustable chamber containing a fluid that can be pressurized in varying degrees by changing the size of the chamber. The curvature of a resilient optical diaphragm at the end of the chamber changes responsive to the changes of the curvature of the fluid producing a lens of variable focal length.

An example of a membrane the shape of which is controlled electrically is disclosed in the U.S. Pat. No. 6,513,939. A combination of dielectric polymer and thin metal layers deform when such a bimorph composite membrane is heated due to application of an ac electric field on the metal layers. An electrically controlled optical switch where a movable shutter is mounted on a smooth flat substrate is disclosed in U.S. Pat. No. 6,907,153. The shutter is made of a thin metal layer which is normally in coiled configuration. When a voltage is applied across the substrate and the shutter, the resulting electric field causes the shutter to uncoil into a flat position over the surface of the substrate. Thus an optical aperture is closed or opens controlling with propagation of a light. Electro-static forces are used to deflect or tilt the mirror disclosed in the U.S. Pat. No. 3,886,310.

An example of optically controlled deformable mirror is described in the U.S. Pat. No. 4,013,345 based on plurality of transparent electrodes on a substrate in combination of a photoconductor layer, elastomer layer and deformable mirror layer. The plurality of electrodes permits biasing voltage on each area of the light valve. The light absorbed in the photoconductive layer creates electron-hole pairs. The voltage applied across the transparent conductor layer and the thin flexible metal layer causes the mobile carriers to drift in the photoconductive layer. Oppositely charged carriers separate creating non-uniform charge pattern and thus causing deformation of the metal mirror layer.

Polymer films that are deformed under the influence of optical radiation without additional requirements of photoconductive and/or metal layers are described in [1-3]. These films are bending in one direction when acted on by radiation of UV wavelengths, and they restore their shape when acted on by radiation of visible wavelengths. Similar photoinduced bending is demonstrated for elastomers doped by azobenzene dyes [4]. Photoresponsive property of the materials described in [1-4] is due to trans-cis photoisomerization processes of their azobenzene molecules and, in case of azobenzene-dye doped elastomers, heating due to absorption of radiation.

Compared to materials that are controlled by electrical, mechanical and other influences, membranes and films that are controlled by optical radiation are advantageous in applications requiring remote control, high resolution addressing, operation in vacuum and hazardous environments. However, all-optical control with the shape of photoresponsive polymers currently requires combination of both UV and visible radiation for reversibility, high power density light beams, and elevated temperature, and the change in the polymer shape takes place in a slow process of several seconds.

### BRIEF SUMMARY OF THE INVENTION

In view of disadvantages of the prior art outlined above, it is the primary objective of this invention to provide means for reversibly controlling with the shape of the polymer with a single light beam of low power density.

Another objective of the invention is to provide means for positive as well as negative angle bending of the polymer film controlled by a single light beam.

Still another objective of the invention is to provide optical control means for inducing large range of polymer deformation angles.

Still another objective of the invention is to provide optical control means for high speed deformation of the polymer film.

Still another objective of the invention is to provide optical control means for obtaining polymer film deformation at room temperature.

Further objectives and advantages of this invention will be apparent from the following detailed description of the preferred embodiment, which is illustrated schematically in the accompanying drawings.

### BRIEF DESCRIPTION OF THE SEVERAL VIEWS OF THE DRAWINGS

FIG. 1 shows schematically the polymer film in different states: (A) undeformed state at the absence of a control light beam; (B) clockwise bent state when the polymer film is acted on by horizontally polarized control light beam; (C) counter-clockwise bending when the polymer film is acted on by vertically polarized control light beam. Photo-inserts in FIGS. 1A, B and C show the side views of an actual polymer film deformed due to the influence of a multimode Ar-Ion laser beam as described in [5].

FIG. 2 shows the bending angle for the polymer film of 3 mm×7 mm×20 μm sizes as a function of power density of the light beam for both vertically and horizontally polarized beams.

FIG. 3 shows the dynamics of bending angle for the polymer film of 1 mm×7 mm×20 μm sizes for both vertically and horizontally polarized beams at fixed power density of the light beam 0.25 W/cm².

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not limitation. The preferred embodiment was disclosed first in [5-7].

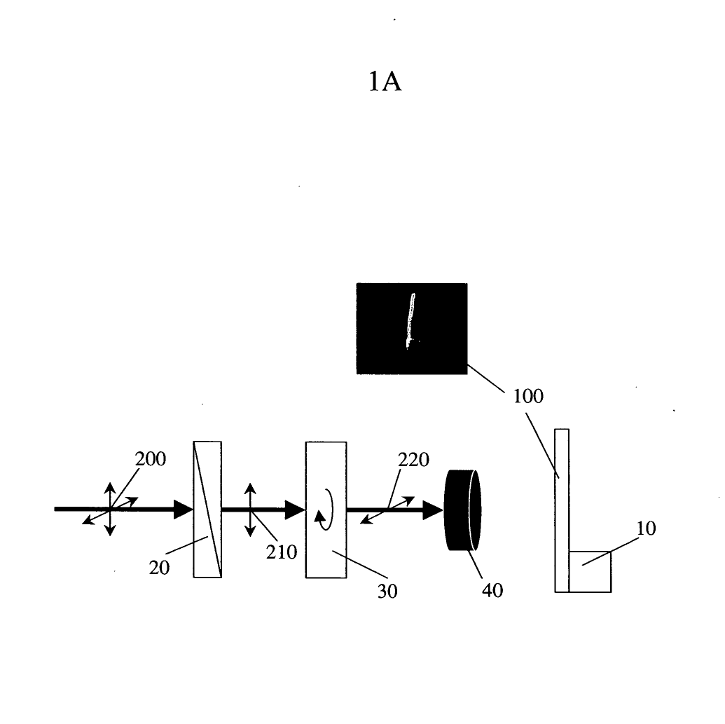

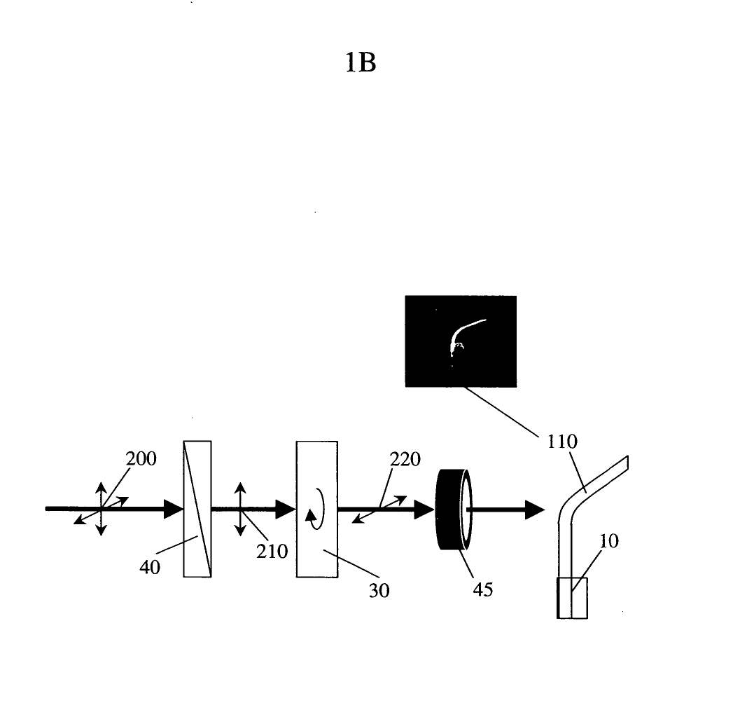

In a preferred embodiment shown in FIG. 1, a polymer film 100, hold by a base plate 10 to which one edge of said film is attached, is arranged on the path of a light beam 220 which may be obtained from an unpolarized light beam 200 after propagating through a polarizer 20 and an optical component 30 with electrically controlled polarization rotating capability such as a twist oriented nematic liquid crystal electro-optical cell. In case the beam 220 is blocked by a shutter 40, the polymer has a flat shape as shown in FIG. 1A. When the shutter is turned into its transmittive state 45, the beam 220 is unblocked and it illuminates said polymer film causing it to assume a bent shape 110 in a process of clock-wise deformation as shown in FIG. 1B. In case the optical component 30 is switched into the state 35 where it does not rotate the polarization of the beam 210, the beam illuminates the polymer film causing it to assume a bent shape 120 in a process of counter clock-wise deformation as shown in FIG. 1C.

In the preferred embodiment the polymer film contains azobenzene liquid-crystalline (LC) moieties similar to the materials described in [1-3] and [5]. Mechanical deformation of azobenzene polymer films is a result of the effects optical radiation has on LC ordering due to photoisomerization of azobenzene molecules that are incorporated into the chemical structure of LCs or are present in the LC network as dopants. There are two distinct processes taking place in LC due to trans-cis photoisomerization of azobenzene chromophores: reorientation normal to the light polarization [8-13], and decrease in the LC ordering followed by phase transition in the polymer network [14-17]. Both processes can contribute into opto-mechanical properties of azobenzene LC networks.

The relative contribution and strength of each process is determined by the wavelength of radiation. Radiation at UV wavelengths corresponds to the maximum of the absorption of azobenzene molecules, consequently, the rate of trans-cis isomerization prevails on the orientational effect. Radiation at longer (visible) wavelengths is at the edges of the absorption band of trans-isomers, but is substantially absorbed by cis-isomers as well resulting in reverse cis-trans isomerization. The sequence of trans-cis isomerization processes followed by cis-trans isomerization results in orientation of the molecules perpendicular to the polarization of the beam.

In the prior art presented in [1-3], bending of the polymer film was obtained by illuminating the polymer with a UV light at the wavelength 366 nm. Even if the orientation of the bending axis of the polymer could be controlled by the polarization of the UV light, only unidirectional bending towards the illumination source was obtained, and the polymer, film needed to be heated to 85° C. The initial flat shape of the polymer could be restored with visible light at 540 nm wavelength. These features of the process are attributed to the shrinkage of the illuminated surface resulting from the difference in sizes of trans and cis isomers.

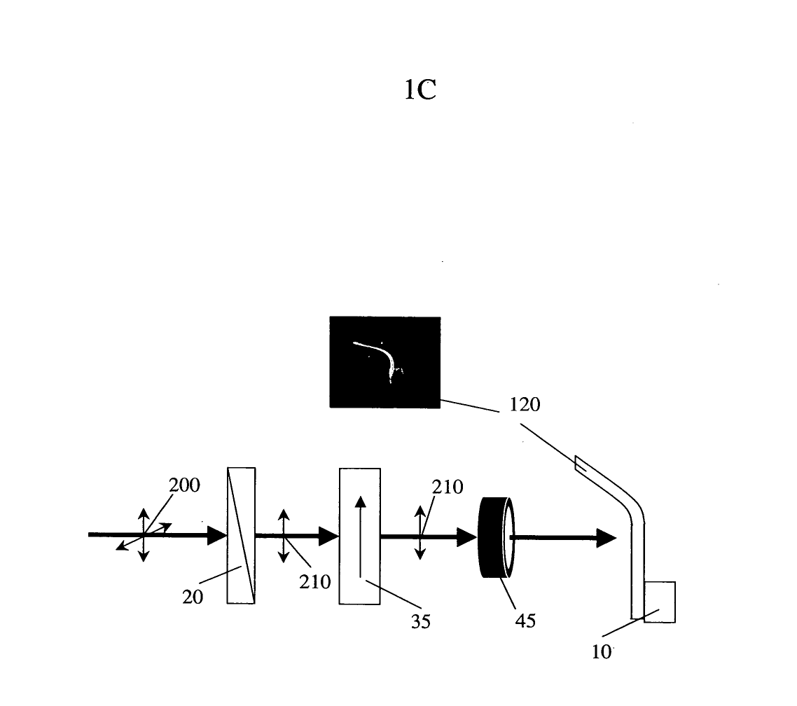

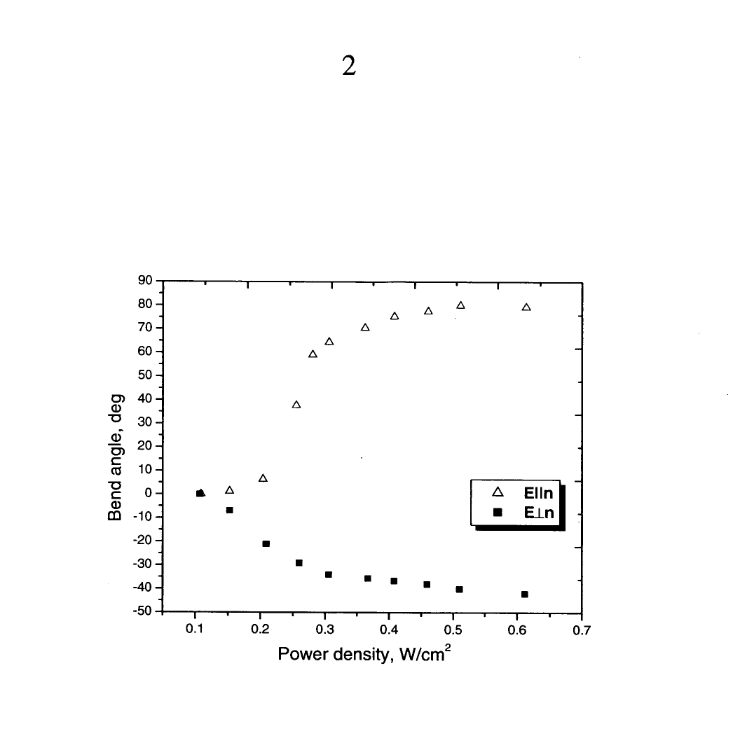

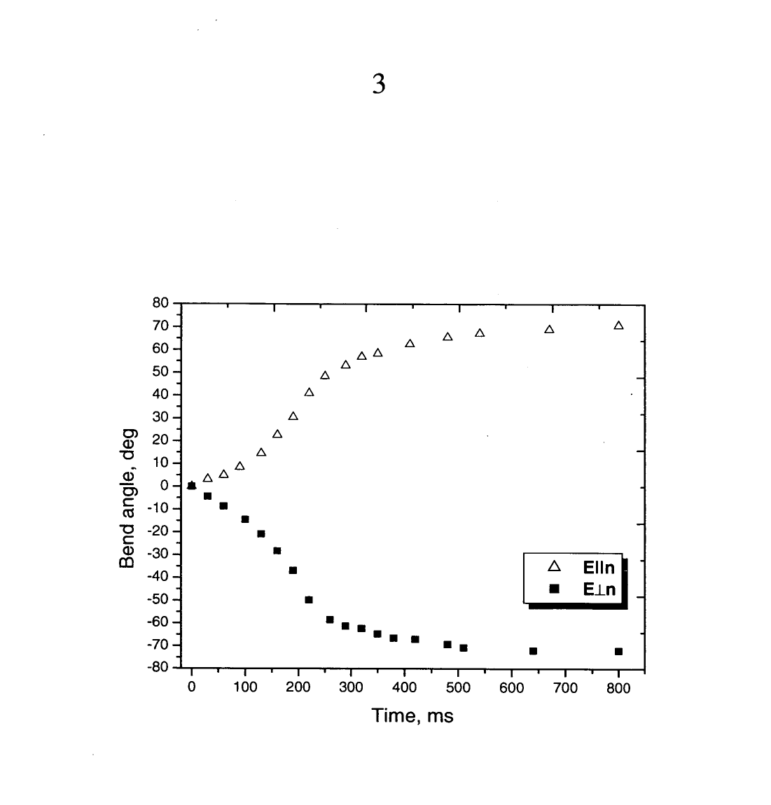

The features of the optical control method of the present invention, including switching of the deformation sign with switching the polarization direction, suggests that optically-induced realignment of LC chromophores and ordering of polymeric chains is the dominant microscopic process taking place in the polymer film at the influence of the beam. Orientation of LC chromophores and polymeric chains contracts the volume of the polymer along the polarization direction and expands it along the direction perpendicular to it. The changes in sizes take place most strongly in areas close to the input surface of the incident beam. The areas closer to the beam exit surface are not much affected due to strong attenuation of light caused by absorption and scattering. Thus, if the polymer film is hold in vertical direction by fixing one of its edges along a horizontal platform, and the incident beam polarization is in the vertical plane, shrinking of the input surface in vertical direction results in bending of the film towards the laser (counter-clockwise in FIG. 1C). In case the beam polarization is in the horizontal plane, the expansion of the input surface in the vertical direction bends the film backwards, away from the laser (clockwise in FIG. 1B). Deformations for other states of polarization can be described from this standpoint as well.

Whereas the sign of deformation angle is controlled by the laser beam polarization, the magnitude of deformation is controlled by the power of the beam as shown in FIG. 2. The deformation of the polymer film is very fast. Complete 700 bending from vertical position is achieved during 400 ms as shown in FIG. 3. This corresponds to an averaged angular speed of 170 degrees/s. The polymer film can be forced into oscillations at nearly 50 Hz frequency by modulating the control light power or polarization. Complete sway from negative to positive end of the bend angles (−70° rad to 70° rad) can be reached in 1.3 s by switching the beam polarization.

The method of optically controlled change in the polymer shape, in accordance with the present invention, offers, among others, the following advantages:
1. the capability of being controlled with a single laser beam;
2. low power density requirement: <0.1 mW/cm²;
3. reversible bidirectional bending of the polymer by switching the polarization of the beam in orthogonal directions;
4. large range deformation angles: >±70°;
5. high speed of photoinduced deformations: 170 degrees/s;
6. high frequency shape modulation: >30 Hz;
7. room temperature functionality.

Although the present invention has been described above by way of a preferred embodiment, this embodiment can be modified at will, within the scope of the appended claims, without departing from the spirit and nature of the subject invention.

What is claimed is:

1. An optical actuation system comprising:
a. a polymer film containing azobenzene moieties;
b. means for holding said polymer film in a predetermined position and orientation;
b. a light source;
c. means for controlling the polarization of said light source;
d. means for controlling the power of said light source;
e. means for directing the light received from said light source onto said polymer film;
f. means for controlling the distribution of light received from said light source on the surface area of said polymer film.

2. The optical actuation system as in claim 1 wherein said polymer film is deformed towards the light source or away from it, homogeneously or inhomogeneously across its surface, by switching the polarization of said light source between orthogonal directions with the aid of said polarization switching means.

3. The optical actuation system as in claim 1 wherein the means for controlling the polarization of said light source comprises an electrically controlled liquid crystal cell acting as a phase modulator or a polarization rotator.

4. The optical actuation system as in claim 1 wherein said light source comprises wavelengths in the spectral range 396 nm-535 nm;

5. The optical actuation system as in claim 1 wherein said means for controlling the distribution of light received from said light source on the surface area of said polymer film comprises a cylindrical lens focusing said beam onto a predetermined area of said polymer, a spherical lens, or a combination of one or more such lenses and other focusing, diffracting and projecting means.

6. The optical actuation system as in claim 1 wherein said polymer film is shaped into a rectangular form or a circular form, or other geometrical form or structure, including a structure of a three-dimensional architecture, which is supported or is fixed along one or more edges or different parts and lengths of its periphery, or its area.

7. The optical actuation system as in claims 1-5 comprising a multitude of independently deformable and optically addressable polymer films or areas said polymer film;

8. The optical actuation system as in claims 1-5 wherein said polymer has one or more areas coated by a mirror reflective layer, electro-conductive layer, or other functional layer such as a wavelength selective reflection layer, or combination of two and more of such layers.

9. Variable optical components such as variable focus mirrors, lenses, light deflectors, shutters, attenuators, switches, comprising the optical actuation system as in claims 1-7.

10. Variable optical components as in claim 8 wherein the deformable polymer film of said optical actuation system serves as a deformable membrane separating two materials with different optical, thermodynamic, and physico-chemical properties.
